(19) United States
(12) Patent Application Publication
(10) Pub. No.: US 2024/0331362 A1
(43) Pub. Date: Oct. 3, 2024

(54) AI SYSTEM AND METHOD TO ENHANCE IMAGES ACQUIRED THROUGH RANDOM MEDIUM

(71) Applicant: FLORIDA ATLANTIC UNIVERSITY BOARD OF TRUSTEES, Boca Raton, FL (US)

(72) Inventors: Bing Ouyang, Vero Beach, FL (US); Dennis Estrada, West Palm Beach, FL (US)

(21) Appl. No.: 18/625,408

(22) Filed: Apr. 3, 2024

Related U.S. Application Data
(60) Provisional application No. 63/493,897, filed on Apr. 3, 2023.

(51) Int. Cl. G06V 10/774; G06T 3/18; G06V 10/24; G06V 10/82; G06V 20/13

(52) U.S. Cl. CPC G06V 10/774; G06T 3/18; G06V 10/24; G06V 10/82; G06V 20/13

(57) ABSTRACT

An exemplary method for training an artificial neural network, along with the associated neural network system, that can learn or account for characteristics associated with spatial domain loss component and a frequency domain loss component, e.g., via Fourier space-loss function. The frequency domain loss component, e.g., via the Fourier space loss function, facilitate the analysis of the turbulence.

### CROSS-REFERENCE TO RELATED APPLICATIONS

This application claims priority to, and the benefit of, U.S. Provisional Appl. No. 63/493,897, filed Apr. 3, 2023, entitled “SYSTEM AND METHOD TO ENHANCE IMAGES ACQUIRED THROUGH RANDOM MEDIUM,” which is incorporated by reference herein in its entirety.

### STATEMENT REGARDING FEDERALLY SPONSORED RESEARCH OR DEVELOPMENT

This invention was made with government support under grant number 2019-67022-29204 awarded by the United States Department of Agriculture/National Institute of Food and Agriculture. The government has certain rights in the invention.

### BACKGROUND

In most remote sensing imaging systems operating in a degraded visual environment (DVE), it is valuable to mitigate image degradation effects, such as blurring, loss of content, geometric distortion, and noise. Among these effects, turbulence-induced image degradation can distort captured images based on the inhomogenous spreading or warping of light waves that are propagated through pockets of the medium that vary in temperature and density. Some processing strategies have been proposed to simulate the degrading effects caused by turbulence; however, these models are generally inaccurate or computationally expensive to perform.

There is a benefit to improving image processing to reduce the distorting effects of turbulence.

### SUMMARY

An exemplary method for training an artificial neural network is disclosed, along with the associated neural network system, that can learn or account for characteristics associated with spatial domain loss component and a frequency domain loss component, e.g., via Fourier space-loss function. The frequency domain loss component, e.g., via the Fourier space loss function, facilitate the analysis of the turbulence. It is observed that Fourier space loss function is beneficial for the restoration of images affected by geometric distortion induced by turbulence, which can be observed by differences within the phase of the Fourier transform of the image. This is the first known application of a Fourier-based image loss to be employed in a machine-learning technique such as generative adversarial network (GAN) for the enhancement of images affected by turbulence-induced degradation.

To improve the turbulence removal, the neural network is trained with a plurality of degraded images that capture the degradation in a turbulent medium with varying turbulence strengths. In addition, to provide for the degree of varying turbulence strengths, a training image can be modified via a physics-based modification of different varying turbulence levels to provide additional training data to the neural network.

To further improve the operation of the neural network operation, a generative adversial network (GAN) may be employed. The GAN includes a discriminator and a generator. The generator can generate output images to the discriminator that is configured to evaluate the output images from the generator against the training data, to train the generator to fool the discriminator (rather than to minimize the distance to a specific image).

The exemplary method and its associated neural network system can remove inhomogenous spreading or warping effects from images, thus mitigating image degradation effects, such as blurring, loss of content, geometric distortion, and noise from images distorted by temperature and density variance in a medium.

The neural network system following this training can be employed to clean blurring, geometric distortion, and noise from images of underwater images distorted by water-turbulent effects, as well as terrestrial and/or satellite images distorted by air-turbulent effects.

In an aspect, the method includes: receiving and/or generating a training data set (e.g., via a simulation model) comprising a plurality of simulated degraded images capturing the degradation in turbulent medium with varying turbulence strengths and corresponding to a target image or object, wherein the plurality of simulated degraded images are provided as multiple frame images into inputsof an artificial neural network (e.g., GAN network); evaluating, by a processor, the performance of the artificial neural network using the multiple frame images to recognize differences between the plurality of degraded images in a turbulent medium and the target image using a perceptual loss function, wherein the perceptual loss function comprises a spatial domain loss component and a frequency domain loss component (e.g., to address distortion affected by spatiofrequency content of an image); and adjusting, by a processor, a weighting parameter of the artificial neural network based on the loss function to generate a trained neural network, wherein the trained neural network is configured to enhance actual images taken in a turbulent medium.

In various embodiments, the artificial neural network comprises ResNet layers.

In various embodiments, the method further comprises globally and locally aligning the plurality of images prior to evaluating the performance of the artificial neural network.

For example, in some embodiments, the perceptual loss function comprises:

$$\\ {}_{P} = {}_{C} + {λ}_{F} {}_{F}$$

wherein ( [symbol] ) is perceptual loss, ( [symbol] ) is a spatial correntropy-based loss component, ( [symbol] ) is a Fourier space-loss function, and (λ_{F}) is a Fourier space-loss weighting parameter.

Additionally disclosed herein are systems configured to perform the methods discussed above.

In another aspect, a system disclosed (e.g., real-time vehicle control or server) comprising: a processor; and a memory having instructions stored thereon, wherein the instructions, when executed by the processor, cause the processor to: receive one or more images having a distortion; generate one or more cleaned images from the received one or more images using a trained neural network having been trained using a perceptual loss function comprising a spatial domain loss component and a frequency domain loss component; and output the generated one or more cleaned images.

In some embodiments, the images include underwater images through turbulence.

In some embodiments, the images include terrestrial images through turbulence.

In some embodiments, the images include satellite images through turbulence.

In some embodiments, the trained neural network was generated by: providing a training data set comprising a plurality of degraded images corresponding to a target image to an artificial neural network; evaluating the performance of the artificial neural network to recognize the differences between the plurality of degraded images and the target image using a perceptual loss function, wherein the perceptual loss function comprises a spatial domain loss component and a frequency domain loss component; and adjusting a weighting parameter of the artificial neural network based on the loss function to generate a trained neural network.

In some embodiments, the perceptual loss function further comprises a spatial correntropy-based loss component (e.g., via a spatial-correntropy-based loss function) and Fourier space-loss functions.

In some embodiments, the system comprises real-time vehicle control configured to employ the one or more cleaned images in the control of the vehicle.

In some embodiments, the system comprises a post-processing system configured to post-process the one or more images having the distortion to generate the one or more cleaned images.

In another aspect, a non-transitory computer-readable medium is disclosed having instructions stored thereon, wherein the instructions, when executed by a processor, cause the processor to: receive one or more images having a distortion; generate one or more cleaned images from the received one or more images using a trained neural network having been trained using a perceptual loss function comprising a spatial domain loss component and a frequency domain loss component; and output the generated one or more cleaned images

In some embodiments, the images include underwater images through turbulence.

In some embodiments, the images include terrestrial images through turbulence.

In some embodiments, the images include satellite images through turbulence.

In some embodiments, the trained neural network was generated by: providing a training data set comprising a plurality of degraded images corresponding to a target image to an artificial neural network; evaluating the performance of the artificial neural network to recognize the differences between the plurality of degraded images and the target image using a perceptual loss function, wherein the perceptual loss function comprises a spatial domain loss component and a frequency domain loss component; and adjusting a weighting parameter of the artificial neural network based on the loss function to generate a trained neural network.

In some embodiments, the perceptual loss function further comprises a spatial correntropy-based loss component (e.g., via a spatial-correntropy-based loss function) and Fourier space-loss functions.

In some embodiments, the processor is employed in a real-time vehicle control configured to employ the one or more cleaned images in the control of the vehicle.

In some embodiments, the processor is employed in a post-processing system configured to post-process the one or more images having the distortion to generate the one or more cleaned images.

### BRIEF DESCRIPTION OF THE DRAWINGS

The accompanying drawings, which are incorporated in and constitute a part of this specification, illustrate embodiments and, together with the description, serve to explain the principles of the methods and systems. The patent or application file contains at least one drawing executed in color.

FIG. 1A shows a system for training and running an artificial neural network configured to learn or account for characteristics associated with a spatial domain loss component and a frequency domain loss component, e.g., via a Fourier space-loss function, in accordance with an illustrative embodiment.

FIG. 1B shows an example method to train a neural network using a perceptual loss function that includes both spatial- and frequency-domain loss components, to be used to subsequently remove turbulence effects from an image degraded by turbulence effect.

FIG. 1C shows an example method that employs a neural network trained using a perceptual loss function that includes both spatial- and frequency-domain loss components, to remove turbulence effects from an image degraded by turbulence effect in accordance with an illustrative embodiment.

FIGS. 2A and 2B each shows an example image degradation process to generate an image with the effects of turbulence, to be used to train a neural network for image enhancement operations in accordance with an illustrative embodiment.

FIGS. 2C and 2D each shows an example of a target image and a corresponding set of degraded images generated from the target image employing the process of FIG. 2A.

FIG. 3A shows a training method for a GAN Image Fusion Network that can operate on multi-image sequences to generate a cleaned image in accordance with an illustrative embodiment.

FIG. 3B shows an example process for the multi-frame image fusion algorithm of FIG. 3A.

FIG. 4A shows a method of using a generative adversarial network to generate a trained neural network employing a perceptual loss function that includes both spatial- and frequency-domain loss components, to remove turbulance effects from a single image degraded by turbulence effect in accordance with an illustrative embodiment.

FIG. 4B shows a method of using a neural network trained to remove turbulence effects from an image degraded by turbulence effect in accordance with an illustrative embodiment.

FIG. 5A shows an example output of the image degradation process of FIG. 2A and a frequency analysis of the same.

FIG. 5B, panels A-F, shows the results of a comparative analysis among different image restoration algorithms. In FIG. 5B, high turbulence images are shown with turbulence index Cₙ²=1×10⁻⁹, which (Panel A) shows target images, (Panel B) shows the degraded input sequences, (Panel C) shows images restored by a lucky region imaging technique, (Panel D) shows output of the TSR-WGAN algorithm, (Panel E) shows the exemplary method with a window size of 256×256, and (Panel F) shows the exemplary method with a window size of 128×128.

FIG. 5C, panels A-F, shows results of another comparative analysis among different filters. In FIG. 5C, (Panel A) shows images acquired in low water turbidity at an optical test facility, (Panel B) shows corresponding scenes taken in higher water turbidity, (Panel C) shows image enhancement results from the Weiner deconvolution filter, (Panel D) shows image enhancement results from a bilateral deconvolution filter, (Panel E) shows image enhancement results from a DeblurGAN method, and (Panel F) shows image enhancement results using th exemplary method.

FIG. 5D, panels A-E, shows the results of a comparative analysis among different image restoration algorithms for shaky images. In FIG. 5D, (Panel A) shows images from a handheld image with handshaking artifacts, (Panel B) shows image enhancement results using a single image frame, (Panel C) shows image enhancement results from a Ghostless Image Fusion algorithm, (Panel D) shows image enhancement results from the Lucky Region Fusion algorithm, and (Panel E) shows image enhancement results using the exemplary method.

FIGS. 6A-6D show results from a simulated turbulence and turbidity environment. In FIG. 6A, a convective tank is shown with the in-water target, FIG. 6B shows the target and detector setup, and FIG. 6C shows the measured turbulence index, Cₙ² versus tank temperature.

FIG. 6D, panels A-H, shows the results of a comparative analysis among different image restoration algorithms for the image acquired in the turbulence and turbidity environment. (Panels A and E) shows degraded images at turbulence index, Cₙ²≈1×10⁻¹⁰ and Cₙ²≈1×10⁻⁹, (Panels B and F) shows image enhancement results from a lucky region imaging technique, (Panels C and G) shows output of the TSR-WGAN algorithm, and (Panels D and G) shows the exemplary method with a window size of 256×256.

### DETAILED DESCRIPTION

Each and every feature described herein, and each and every combination of two or more of such features, is included within the scope of the present invention, provided that the features included in such a combination are not mutually inconsistent.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entirety and to the same extent as if each reference was individually incorporated by reference.

### Example System

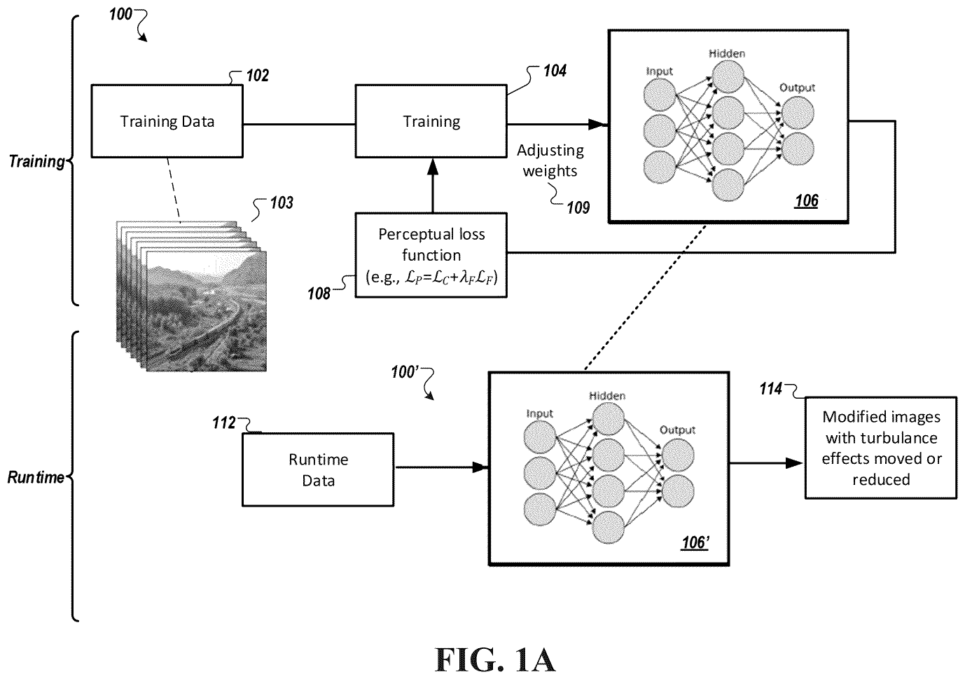

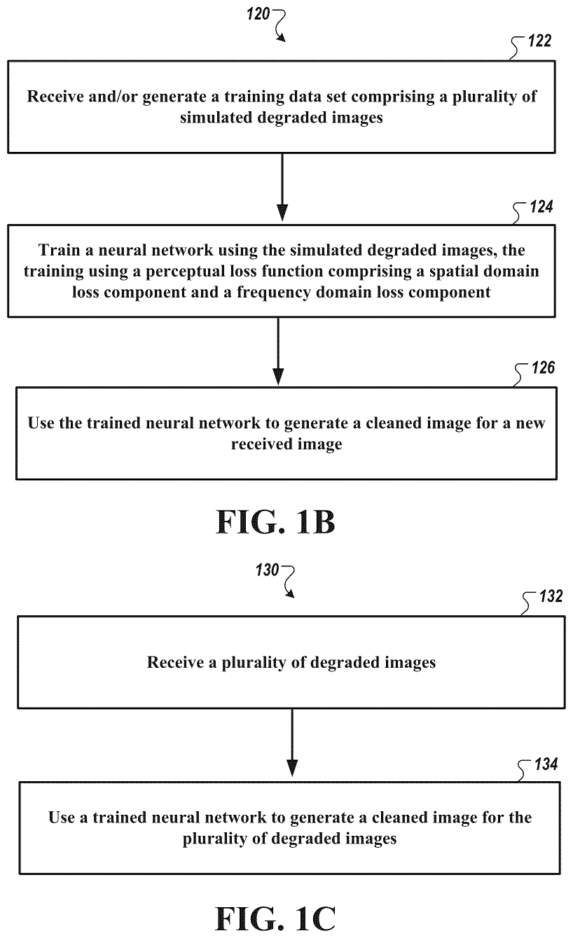

FIG. 1A shows a system 100 for training and running an artificial neural network configured to learn or account for characteristics associated with a spatial domain loss component and a frequency domain loss component, e.g., via Fourier space-loss function. The exemplary method and its associated neural network system can remove inhomogenous spreading or warping effects from images, thus mitigating image degradation effects, such as blurring, loss of content, geometric distortion, and noise from images distorted by temperature and density variance in a medium.

In the example shown in FIG. 1A, the training system 100 employs training data 102 comprising a plurality of degraded images 103 corresponding to a target image and provides it to the training operation 104 for an artificial neural network 106. In the training operation 104, the performance of the artificial neural network 106 is evaluated to recognize the differences between the plurality of degraded images and the target image using a perceptual loss function 108 having both a spatial domain loss component and a frequency domain loss component, e.g., based on Fourier spatial-loss function. Based on the resulting perceptual loss function 108, the training system 100 adjusts the weighting parameter (109) of the artificial neural network 106 to generate a trained neural network 106′.

Subsequently, the trained neural network 106′ can be employed in a run time system 100′ to operate on runtime data 112 where it 100′ is used to produce modified images 114 with turbulence effects removed or reduced.

### Example Method of Operation

Method of training. FIG. 1B shows an example method 120 to train a neural network using a perceptual loss function that includes both spatial- and frequency-domain loss components, to be used to subsequently remove turbulence effects from an image degraded by turbulence effect.

Method 120 includes receiving and/or generating (122) a training data set comprising a plurality of simulated degraded images capturing the degradation in a turbulent medium with varying turbulence strengths and corresponding to a target image or object, wherein the plurality of simulated degraded images are provided as multiple frame images into inputs of an artificial neural network.

Method 120 then includes training (124) a neural network using the simulated degraded images, the training using a perceptual loss function comprising a spatial domain loss component and a frequency domain loss component. The training (124) can include evaluating, by a processor the performance of the artificial neural network using the multiple frame images to recognize differences between the plurality of degraded images in a turbulent medium and the target image using a perceptual loss function, wherein the perceptual loss function comprises a spatial domain loss component and a frequency domain loss component.

Training 124 then includes adjusting, by a processor, a weighting parameter of the artificial neural network based on the loss function to generate a trained neural network, wherein, once trained, the trained neural network is configured to enhance actual images taken in a turbulent medium.

Method 120 may then include using the trained neural network to generate a cleaned image for a newly received image.

Method of Use. FIG. 1C shows an example method 130 that employs neural network trained using a perceptual loss function that includes both spatial- and frequency-domain loss components, to remove turbulence effects from an image degraded by turbulence effect. Method 130 includes receiving (132) a plurality of degraded images. Method 130 then includes using (134) a trained neural network, e.g., generated per the method described in relation to FIG. 1B, to generate a cleaned image for the plurality of degraded images.

The trained AI may be used for removing turbulence effects from underwater images, terrestrial images, or satellite images.

Example Training Data Generation having Turbulence-Induced Degradation

To employ AI to remove turbulence from an image degraded by turbulence, training images with turbulence has to be used. Often, the availability of such images is not prevalent. To generate such training data, a simulation of the effects of turbulence can be performed and applied to an input image to enhance variation in turbulent strength in the input image to be applied to the training.

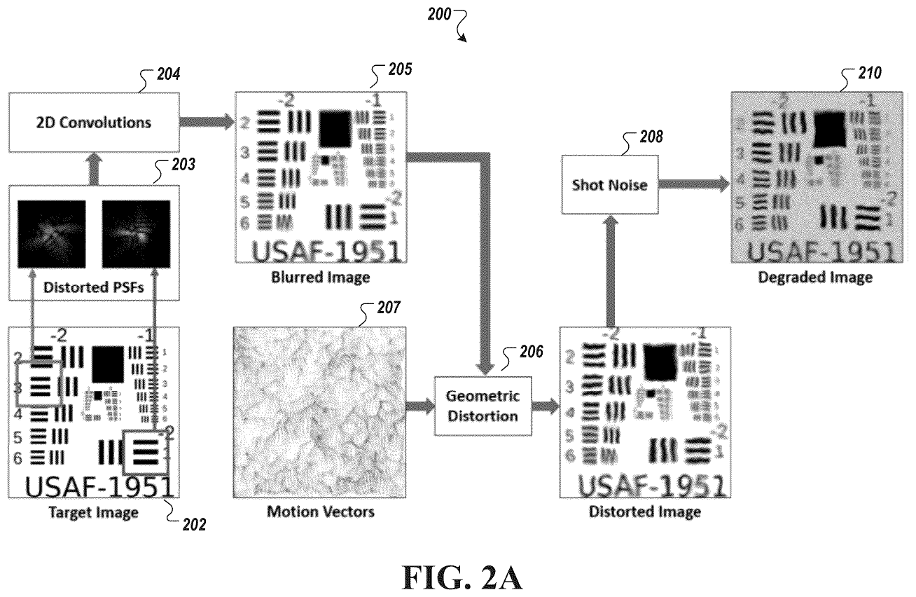

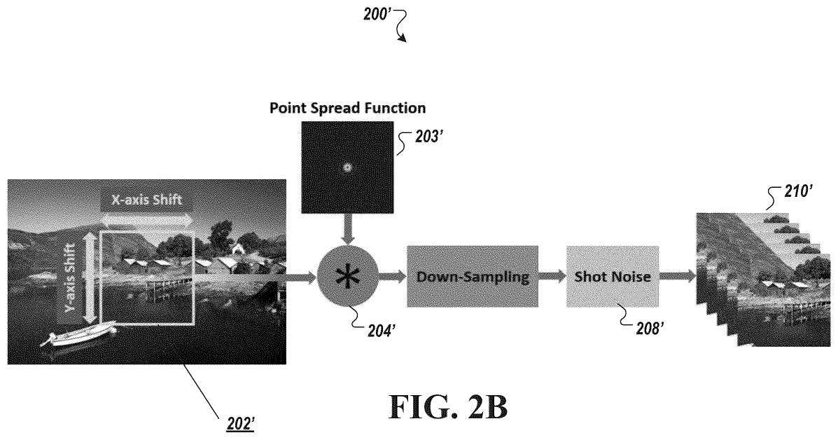

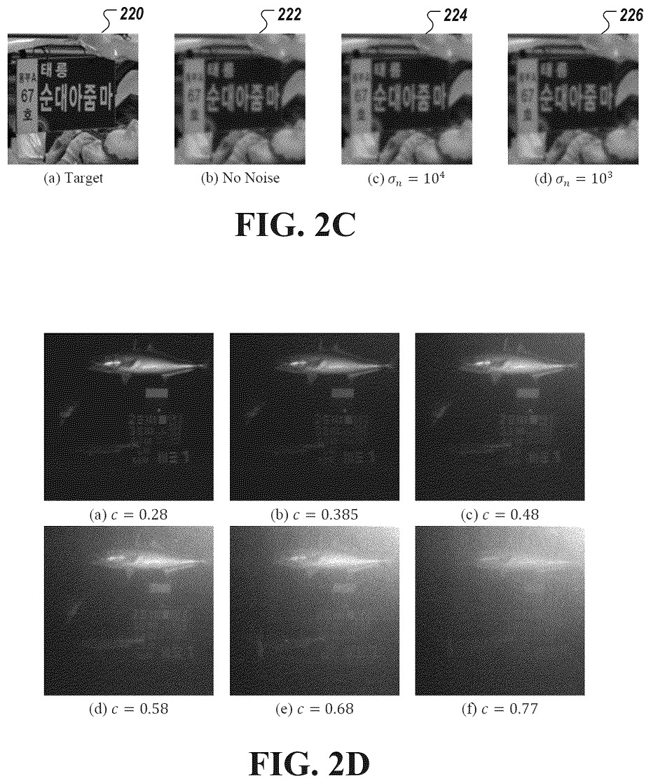

FIG. 2A shows an example image degradation process 200 to generate an image with the effects of turbulence. In the example of FIG. 2A, to generate a training image set, a single source image 200 can be partitioned into smaller blocks and used to generate a set of corresponding spatially varying distorted point spread functions (203),
PSF_{d}={PSF_{x,y}}, x=1, y=1M₁, M₂, e.g., using higher-order Zernike coefficients with inter-modal correlation. Each partitioned block can then be blurred by convolving it, e.g., via a convolution operation 204, with the corresponding PSF (e.g., to generate blurred image 205).

A set of random motion vectors (207), Mᵥ={M_{x,y}}, x=1, y=1, M₁, M₂, that are spatially correlated throughout the entire image can be generated using a randomized sampling scheme, such as that disclosed in Chimitt et al. (2020). The motion vector (207) provides the offset values from which the pixel from the reference image is translated to the final position in the distorted image, M_{x,y}=[Δx_{x,y}, Δy_{x,y}]. The generated tilt maps can then be used to geometrically warp or distort the image via a geometric distortion operator 206. An example description for the generation of the random distortions and motion vectors, e.g., for generation of 207, based on the length of the propagation, L, and the refractive structure index parameter, Cₙ² (z), can be found in Chimitt et al. (2020), which is hereby incorporated by reference in its entirety.

In general, the image degradation model (e.g., for 200) for images affected by turbulence is described per Equation 1.

$$\\ \begin{matrix}{Y}_{t} = 𝒩 ( ( {PSF}_{d} ( d , {f}_{L} , λ , {C}_{n}^{{}_{} 2} , L , t ) * X ) ⊙ {M}_{v} ( d , {f}_{L} , λ , {C}_{n}^{{}_{} 2} , L , t ) , {σ}_{𝒩} & ( Eq . 1 )\end{matrix}$$

In Equation 1, X is the clean or target image (202), * and ⊙ are the 2D convolution (204) and geometric distortion operators (206), [symbol] is an applied shot noise process (208), [symbol] is the noise scale parameter, and Yₜ is the degraded image (210) at time instance t. The 2D convolution (204) is given by the relation described in Equation 2.

$$\\ \begin{matrix}B ( x , y ) = {PSF}_{x , y} * X ( x , y ) = {\sum }_{dx = - \frac{a - 1}{2}}^{\frac{a - 1}{2}} {\sum }_{dy = - \frac{a - 1}{2}}^{\frac{a - 1}{2}} {PSF}_{x , y} ( dx , dy ) \cdot X ( x + dx , x + dx ) & ( Eq . 2 )\end{matrix}$$

In Equation 2, i and j are pixel indices, PSF_{xy} is the point spread function (203) given as a 2D matrix of size a×b for the specified pixel coordinate (x,y), and B is the blurred image at a given time instance. The geometric distortion function (206) can be described per Equation 3.

$$\\ \begin{matrix}D ( x , y ) = B ( x , y ) ⊙ {M}_{x , y} = B ( x + Δ {x}_{x , y} , y + Δ {y}_{x , y} ) & ( Eq . 3 )\end{matrix}$$

Typical camera sensors can be affected by photon shot noise, photo-response nonuniformity (PRNU), crosstalk, and dark channels. As one non-limiting example, Photon shot noise (e.g., 208) can be used to simulate the noise collected by the sensor. It has been found that the distribution for a given window tends to follow a Poisson distribution, with variance equal to the mean arrival rate. Shot noise can be applied pixel-wise by generating a random number from a Poisson distribution with the intensity value used as the mean. The intensity of the shot noise applied to the image is controlled by scaling the pixel intensity values of the image by the noise scale parameter, [symbol] , and rescaling the intensities after the noise has been applied.

FIG. 2B shows another example image degradation process 200 (shown as 202′) to generate an image with the effects of turbulence. In FIG. 2B, an image patch (202′) is cropped from the high-resolution image, and the proceeding crops are randomly shifted on the X and Y-axis. The cropped images 202′ are then blurred using an airy disk point spread function (PSF) (203′) and then downsampled. Shot noise (208′) is then applied to get the simulated degraded, low-resolution, and noisy images.

The image degradation model can be expressed per Equation 4.

$${Y}_{t} = 𝒩 ( D ( P S F ( d , {f}_{L} , λ ) * X , s ) , {σ}_{𝒩} ) \qquad ( Eq . 4 )$$

In Equation 4, X is the high-resolution image, PSF is a uniform point spread function (203) (shown as 203′), * is the convolution operator 204 (shown as 204′), D(·) is the down-sampling operation, s is the scale to perform the down-sample, and [symbol] (·) is the noise process this is dependent on the noise scale, [symbol] . The PSF is dependent on the desired lens aperture size d, focal length f_{L}, and the observed wavelength of light. The down-sampling process is used to simulate the lost image detail caused by the under-sampling of the scene. This under-sampling is directly related to the pixel size and resolution of the CMOS detector. Shot noise is then applied to the degraded image to simulate the noise from the detector. FIG. 2C shows an example of a target image 220 and a corresponding set of degraded images (222, 224, 226) generated from the target image. The other images are shown with degradation with no noise added (222), with [symbol] =10⁴ (224), and [symbol] =10³ (226).

Degraded LiDAR images. LiDAR uses light in the form of lasers to measure the distance of objects that are in the line of sight of the transmitter and receiver. LiDAR systems typically consist of a laser transmitter, scanner, and receiver. In time-of-flight (ToF) LiDAR systems, a rapidly firing laser emits a pulse of light toward the target, where it is reflected.

For LiDAR images, the image degradation model can be expressed per Equation 5.

$${Y}_{t} = {𝒩}_{S} ( P S F * X + {𝒩}_{G} ( {μ}_{g} , {σ}_{g} ) ) , {σ}_{𝒩} ) \qquad ( Eq . 5 )$$

In Equation 5, where X is the target image, PSF is the point spread function that captures blur due to the forward scattering effect, [symbol] (·) is the applied shot noise process that represents the PMT detector noise, [symbol] is the noise level, and [symbol] is the additive Gaussian noise with the mean μ_{g} and variance σ_{g} that reflects the laser instability. To create the dataset, LiDAR measurement can be scanned of static artificial targets in varying water turbidity levels. FIG. 2D shows intensity images captured via LiDAR to which a synthetic dataset is generated using the images captured at the lowest turbidity level. The images may be used as target training data for the image enhancement algorithm. In FIG. 2D, the LiDAR employed a red laser at 638 nm that is degraded using the method described herein. In FIG. 2D, the images can become more degraded as the beam attenuation increases due to forward and back scatter caused by image blur and loss of contrast.

### Example Method of Training a Neural Network for Multi-Image Sequence

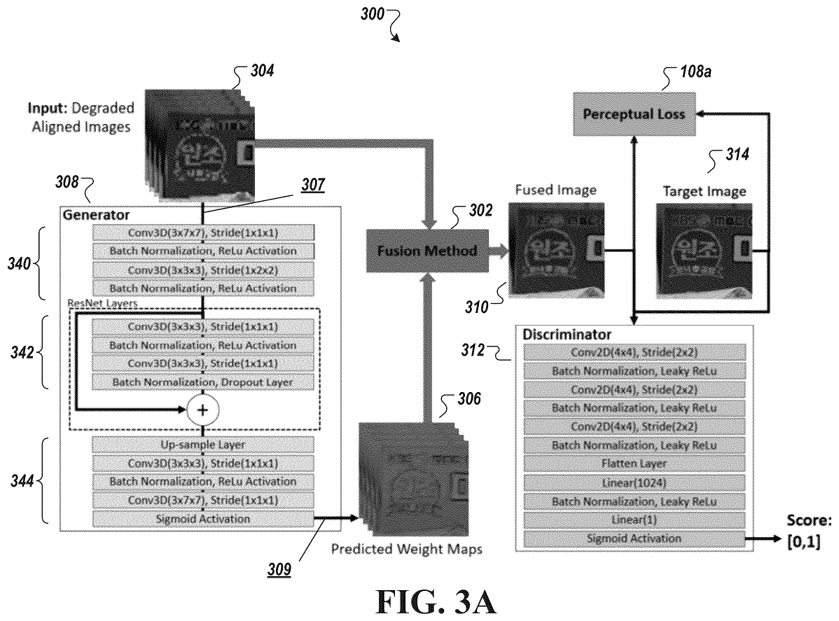

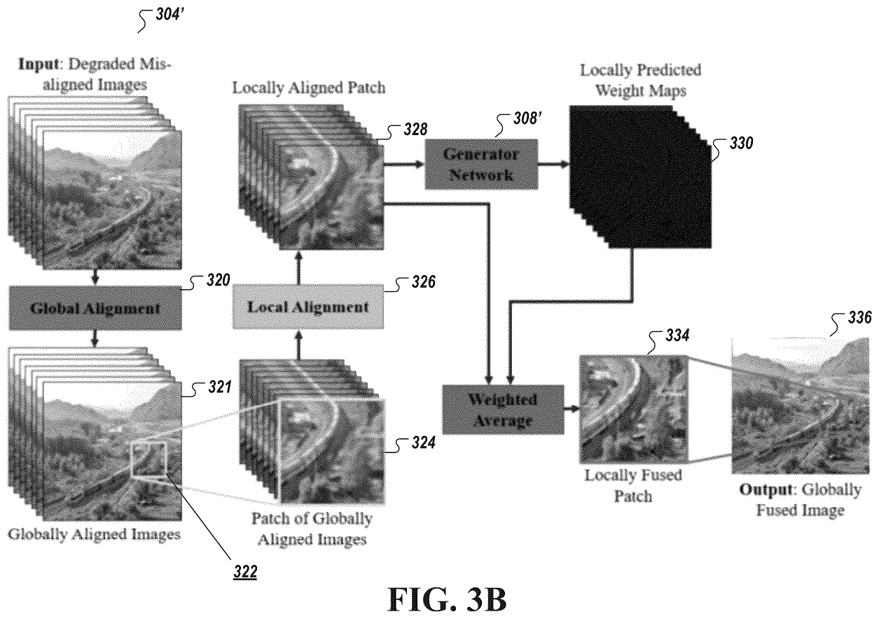

FIG. 3A shows the training of a GAN Image Fusion Network 300 that can operate on multi-image sequences to generate a cleaned image. In FIG. 3A, the exemplary multi-frame GAN Image Weight Predictor and Fusion Network 300 employs the perceptual loss function 108 (shown as 108a), having both a spatial domain loss component and a frequency domain loss component. In the example shown in FIG. 3A, the GAN system 300 includes a fusion process 302 (shown as “fusion method” 302) that is employed to fuse input image sequences that are aligned together. Multi-frame data 304 can provide additional scene detail than a single image. In the case of a scene disturbed by turbulence, multi-frame data 304 can allow a better chance of capturing the information of the original scene content than a single image.

The objective of the GAN Image Fusion Network 300 is to predict the optimal weight maps 306 to use in the fusion method 302 given a sequence of pre-aligned images 304. A generator network 308 takes as input the aligned images 304 and outputs the predicted weight maps 306. The aligned image 304 and predicted weight maps 306 are then used in the fusion process 302 to form the fused image 310. The discriminator network 312 then scores the fused image 310 and target image 314 to guide the generator 308. The perpetual image loss 108a is then computed between the fused 310 and target image 314.

FIG. 3B shows an example process for the multi-frame image fusion algorithm. In FIG. 3B, the images 304 (shown as 304′) may be globally aligned (320) to the temporal average of the sequence with sub-pixel accuracy, e.g., using a single-step DFT algorithm. A moving window method (322) may then be used to crop a localized patch (324) from the globally aligned image stack (321). A second iteration (326) of the single-step DFT may be performed on the localized patches (324) to minimize misalignments to the temporal average. The locally aligned patches (328) may then be used as the input of a convolutional neural network (e.g., 308, shown as 308′) to a set of weight maps (330) that corresponded to the images in the sequence. The localized image patches (328) and corresponding weight maps (330) may then be used to take the average of the point-wise multiplication (shown as “weighted average” 332) to output the locally fused patch (334). The locally fused patches (334) may then be stitched together to form the globally fused image (336).

Example GAN-based Image Weight Predictor. In FIG. 3A, the exemplified network 300 used a set of misaligned degraded images 304 of the same static scene or object that is captured, e.g., using a monochromatic camera system within a turbulent medium or other imaging system described herein.

Alignment Algorithm. The alignment algorithm may be employed to achieve image registration using a rigid 2D transform. A single-step discrete Fourier transform (DFT) algorithm such as the one used in Zheng et al. (2008), can be used to find the sub-pixel shifts [xₛ,yₛ] within a desired fraction. The operation can be performed by minimizing the normalized root mean square error (NRMSE), E, between a base frame, h, and the registered frame, g. This is given as Equation 6.

$${E}^{2} = {min}_{a , {x}_{s} , {y}_{s}} \frac{{\sum }_{x \cdot y} {\vert α g ( x - {y}_{s} , x - {y}_{s} ) - h ( x , y ) \vert}^{2}}{{\sum }_{x \cdot y} {\vert h ( x , y ) \vert}^{2}} = 1 - \frac{{max}_{{x}_{s} , {y}_{s}} {\vert {r}_{A B} ( {x}_{s} , {y}_{s} ) \vert}^{2}}{{\sum }_{i , j} {\vert h ( x , y ) \vert}^{2} {\sum }_{i , j} {\vert g ( x , y ) \vert}^{2}} \qquad ( Eq . 6 )$$

In Equation 6, the summations are performed across all pixel coordinates (i,j), and the cross-correlation between images h and g is given as Equation 7.

$${r}_{h g} ( {x}_{s} , {y}_{s} ) = {\sum }_{x , y} h ( x , y ) g * ( x - {x}_{s} , y - {y}_{s} ) = {\sum }_{u , v} H ( u , v ) G * ( u , v ) exp [ j 2 π ( \frac{u {x}_{s}}{{M}_{1}} + \frac{v {y}_{s}}{{M}_{2}} ) ] \qquad ( Eq . 7 )$$

In Equation 7, H and G is the DFT of the images h and g, M₁ and M₂ are dimensions of the image, and G* is the complex conjugate of G. The DFT is given by the relation, per Equation 8.

$$H ( u , v ) = {\sum }_{x , y} \frac{h ( x , y )}{\sqrt{{M}_{1} {M}_{2}}} exp [ j 2 π ( \frac{u x}{{M}_{1}} + \frac{v y}{{M}_{2}} ) ] \qquad ( Eq . 8 )$$

Thus, the task of registering the image is simplified to finding the peak cross-correlation r_{hg}(x,y) to obtain the optimal sub-pixel shifts [xₛ,yₛ]. This can be performed by taking an upsampled DFT of the images h and g by a factor of k. The product HG* is then cast to a matrix of size [k_{M1},k_{M2}], and an inverse DFT is performed to obtain the cross-correlation r_{hg}. The pixel coordinates [xₛ,yₛ] with the highest correlation denoting the optimal shift to be applied to image g to be aligned with image h. This allows for a sub-pixel accuracy of 1/k. In Guizar-Sicarios et al. (2008), a single-step DFT algorithm was proposed to speed up computational time while maintaining accuracy. This was achieved by using a matrix multiplication implementation of the DFT to only calculate the DFT around a small neighborhood of the peak.

In the exemplary alignment operation, the camera and scene of interest can be assumed to be static; thus, all movement throughout the scene is related to turbulence. For situations with low turbulence, the global alignment of all the frames to the temporal average of the image sequence can be sufficient. Each frame may be first registered to the base frame to obtain the sub-pixel shift vectors [xₛ,yₛ], and the 2D translation transform is then applied to each image. However, for severe turbulence, a refinement of this alignment can be performed by processing the images using the moving window method. A moving window of size K×K may be used to crop out a patch from the stack of globally aligned images. These patches of images can then be locally registered using the second iteration of the single-step DFT algorithm to refine the initial global alignment of the image. The size of the moving window is dependent on the strength of the turbulence applied to the image. For cases where more turbulence or geometric distortion is prevalent, a smaller window size may be beneficial. However, using a smaller window size can lead to longer processing times.

Several intensity-based and feature-based image registration algorithms have been proposed, e.g., Zitova et al. (2003). However, for mapping the low-resolution image onto a common high-resolution plane, a sup-pixel accurate algorithm is desired. Alignment algorithms aim to register the images onto a common high-resolution plane regarding a base frame. For example, if the first frame is taken as the base frame, then all consecutive frames are aligned pixel-wise with sub-pixel accuracy. If the aligned images are then overlaid onto each other, the resulting image is a higher-resolution image. The alignment algorithm depicted in Wronski et al. (2019), uses a coarse-to-fine pyramid-based matching technique that performs a limited window search for the most similar tiles. This alignment is then followed by a refinement using several iterations of the Lucas-Kanade optical flow image warping to estimate the alignment vectors. The alignment vector contains the translation sub-pixel shifts for each of the corresponding pixel elements in the stack of images. An important step in performing the registration is the selection of an appropriate base or reference frame to which the sequence of images is aligned to. Since the input images are geometrically warped, using a single frame from the sequence can lead to misalignments in the final fusion process. For static scenes, several methods use the temporal average of the sequence as the base frame. Zhu et al. (2012); Aubailly et al. (2009). In Mao et al. (2020), the base frame was constructed using a space-time non-local averaging method to stabilize the images without distorting moving objects.

Weight Map Prediction and Fusion Network. The weight maps (306) can be used to determine the pixel-wise weights that correspond to the amount of certainty that that specific pixel is used in the final fused image. The weight maps (306) can be grey-scale images with each pixel within the range [0,1], and each weight map corresponds to an image in the stack.

The image fusion process (302) can merge the set of aligned images into a single high-resolution image. Several different image fusion processes have been proposed to merge several images. In Wronski, the weight maps were utilized by multiplying the weights directly with the aligned images and then performing a median across each stack of pixels to form the high-resolution image. In Hayat, the researchers incorporated a pyramidal-based method to fuse the images within a Laplacian pyramidal-based decomposition and then perform a reconstruction to get the fused image.

GAN-Based Weight Prediction. The exemplary weight map prediction (306) can be performed using a conditional Wasserstein Generalized Adversarial Network combined with a gradient penalty (CWGAN-GP). A reference CWGAN-GP is provided in Zheng et al. (2020); Isola et al. (2017), each of which is incorporated by reference in their entireties.

The CWGAN-GP network may be a combination of two different sub-networks: a generator network (G) (308), and a discriminator network (D) (312). The input (307) of the generator network (308) may be a stack of N aligned degraded images (Y={Yⱼ}^{N}ⱼ₌₁) (e.g., 304), and the output (309) is a prediction of the corresponding weight maps (W={Wⱼ}^{N}ⱼ₌₁) (306). The restored image (e.g., fused image 310) can then be generated by taking the average of the point-wise multiplication of the degraded images (304) and weight maps (306). This is given as Equations 9 and 10.

$$G ( Y ) = W \qquad ( Eq . 9 )$$

$$\hat{X} = \frac{1}{N} {\sum }_{j = 1}^{N} {Y}_{i} {W}_{j} \qquad ( Eq . 10 )$$

The discriminator network 312 can then score the restored image (310) and target image (X) (314) based on how fake or real they look. The networks (308, 312) may be trained simultaneously until the discriminator 312 cannot differentiate between the restored 310 and target samples 314. Once the networks 308, 312 have been fully trained, only the generator network 308 can be employed as network 106′ for restoring images. The CWGAN-GP value function can be represented as a two-player minimax game given by the following objective, per Equation 11.

$${min}_{G} {max}_{D ∈ 𝒟} {E}_{X ∼ {𝒫}_{x}} [ D ( X ) - {E}_{Y ∼ {𝒫}_{y}} [ D ( \hat{X} ) ] \qquad ( Eq . 11 )$$

In Equation 11, [symbol] is the set of 1-Lipschitz functions, E[·] is the expectation, [symbol] x is the distribution of the target images, and [symbol] _{y} is the distribution of the degraded images. The critic value approximates [symbol] ·W( [symbol] ₓ, [symbol] ₓ), where [symbol] is a Lipschitz constant, and W ( [symbol] ₓ, [symbol] ₓ) is the Wasserstein distance. To enforce the Lipschitz constraint, a gradient penalty may be enforced on the discriminator. The penalty can be expressed as Equation 12.

$$G P = {λ}_{gp} {E}_{\overline{X} ∼ {𝒫}_{\hat{x}}} [ {( {‖ {∇}_{\overline{X}} D ( \hat{X} \vert Y ) ‖}_{2} - 1 )}^{2} ] \qquad ( Eq . 12 )$$

In Equation 12, λ_{gp} is the gradient penalty coefficient, and V is the gradient operator. It has been shown in that CWGAN-GP generates perceptually convincing data and overcomes the problems of mode collapse, vanishing gradients, and unstable training.

Several methods have been used to find the weight maps for a set of images that share the same scene or object but may differ in contrast, exposure, and dynamic obstructions. They may be alternatively employed herein.

In Hayat et al. (2003), the researchers incorporated a weight map that was formulated through the combination of a contrast map calculated using a dense SIFT descriptor, an exposure map, and a color-difference map. The incorporated color difference map was used for finding pixels that are not correlated to the base-frame pixel and helps remove ghost-like artifacts, caused by moving objects within the scene and noise from the final fused image. In Wronski, a weight map was proposed that is similar to the color-difference map used in Hayat but incorporates the alignment vectors to classify each pixel as aliased or misaligned or a noisy pixel and apply a conditional weight.

Discriminator Network. The input of the discriminator 312 may be a square image of size M×M and is implemented by 2D convolutional layers. The input layer may include filters having a defined kernel size (e.g., 32 filters with a kernel size of 4×4 and a stride of 2×2) and is followed by a batch normalization layer and Leaky ReLu activation function. The second and third layers may have similar parameters but may have different filters (e.g., 16 and 8 filters, respectively). The tensor may then be flattened, and a dense layer may be followed by a batch normalization layer. The Leaky ReLu activation function can then be applied to give a vector (e.g., 1024 elements). The output layer may include a linear convolution with a sigmoid activation function to give a single output value or score within the range [0,1]. The objective of the discriminator may be to minimize the discriminator loss, e.g., per Equation 13.

$${ℒ}_{D} = - {\sum }_{m = 1}^{M} D ( {X}_{m} ) + {\sum }_{m = 1}^{M} D ( {\hat{X}}_{m} ) + {λ}_{gp} {\sum }_{m = 1}^{M} {( {‖ {∇}_{\hat{X}} D ( {\hat{X}}_{m} ) ‖}_{2} - 1 )}^{2} \qquad ( Eq . 13 )$$

In Equation 13, M is the number of image pairs used in training, and λ_{gp} is scaling value (e.g., set as 10) in the training.

Generator Network. The weight map generator 308 may include 3D convolutional layers that are followed by a batch normalization layer and a ReLu activation function (collectively shown as 340). The input of the generator may be a stack of aligned square images with dimensions N×M×M. The input layer may include convolutional layers (e.g., 32 convolution layers) with a kernel size (e.g., 3×7×7). This may be followed by an encoding convolution layer that downsamples the images and doubles the number of channels. This is performed by using 64 convolution filters with a kernel size of 3×3×3 and a stride of 1×2×2.

The data may then be passed through multiple residual blocks (shown collectively as 342), referred to as ResBlocks (e.g., 3 residual blocks). Each ResBlock included a convolution layer with kernel size 3×3×3 and a second convolution with kernel size 3×3×3. Similar to Kupyn et al., a dropout regularization with a probability of 0.5 may be employed for each ResBlock after the first convolution layer.

A decoder convolution layer (collectively shown as 344) may then then used to upsample the image and halve the number of channels. The upsampling may be performed by doubling the rows and columns of the image and performing a convolution with kernel size (e.g., 3×3×3). The output layer may include a final convolution layer with kernel size (e.g., 3×7×7) followed by a sigmoid activation function. The objective of the generator mnay be set to minimize the overall generator loss ( [symbol] ) that is given as a combination of adversarial loss ( [symbol] ) and perceptual loss ( [symbol] ), per Equation 14.

$${ℒ}_{G} = {ℒ}_{P} + {λ}_{A} {ℒ}_{A} \qquad ( Eq . 14 )$$

In Equation 14, λ_{A} is a weighting parameter that regulates the influence of the adversarial loss on the generator loss and maybe set, e.g., to 0.001, in the training. The adversarial loss is the summation of negative scores of the generated image given by the discriminator network, per Equation 15.

$${ℒ}_{A} = {\sum }_{m = 1}^{M} - D ( {\hat{X}}_{m} ) \qquad ( Eq . 15 )$$

Perceptual Loss Function. The perceptual loss function may be used to guide the generator network (312) by comparing low-level and high-level differences between the restored (310) and target image (314). The function can be specifically constructed to capture the texture and style differences within a specified noise distribution. Thus, a loss function may be utilized that can effectively recover corrupted image detail in this type of noise setting. Although the mean square error (MSE) or L2-loss function can be easily differentiated and convex, making it convenient for optimization tasks, issues can remain as an image quality metric because it can assume that noise is independent of the local characteristics of the image. Without wishing to be bound by theory, because the noise sensitivity of the Human Visual System (HVS) is dependent on the local luminance, contrast, and structure, it is believed that the Mean absolute error or L1-loss function could be a better image loss function as it does not over penalize large errors and encourages less high-frequency noise. Moreover, using multiple loss functions to formulate a custom perceptual loss can improve performance. The perceptual loss may be implemented as a combination of a spatial correntropy-based loss ( [symbol] ) and a Fourier space loss ( [symbol] ), e.g., per

$${ℒ}_{P} = {ℒ}_{C} + {λ}_{F} {ℒ}_{F} \qquad ( Eq . 16 )$$

In Equation 16, the λ_{F} is a weighting parameter that regulates the impact of the Fourier space loss on the total perceptual loss and is set, e.g., to 0.01, in the training. The combination of the Correntropy loss and Fourier space loss in the overall perceptual loss function can allow the network (e.g., 312) to compare the restored (310) and target image (314) in both the spatial and frequency domain. In regression and classification tasks, the correntropy-loss (C-loss) function can be used as a similarity measure between the distribution of two unknown random variables. Correntropy may be useful for cases where the noise distribution is non-gaussian and has a non-zero mean and large outliers. The correntropy loss function can provide better results compared to the L1 and L2 loss functions when the image is affected by non-gaussian noise. An example correntropy loss function for a 2-dimensional image is given in Estrada et al. (2022), which is incorporated by reference herein.

Fourier Space Loss. The Fourier space loss, [symbol] , can be used to supervise the training network within the frequency spectrum. This may be performed by transforming both the target, X, and the restored image, X, by applying the Fast Fourier Transform, [symbol] {·}, where the amplitude and phase components were calculated. The average of the amplitude differences, [symbol] _{F,∥}, and phase differences, [symbol] _{F,∠} can give the overall Fourier space loss function, [symbol] _{F}, per Equation Set 17.

$${ℒ}_{ℱ , ‖} = \frac{1}{{M}^{2}} {\sum }_{i = 0}^{M} {\sum }_{j = 0}^{M} {‖ {\vert ℱ \{ X \} \vert}_{i , j} - {\vert ℱ \{ \hat{X} \} \vert}_{i , j} ‖}_{1} \qquad ( Eq . Set 17 )$$

$${ℒ}_{F , ∠} = \frac{1}{{M}^{2}} {\sum }_{i = 0}^{M} {\sum }_{j = 0}^{M} {‖ ∠ ℱ {\{ X \}}_{i , j} - ∠ ℱ {\{ \hat{X} \}}_{i , j} ‖}_{1}$$

$${ℒ}_{ℱ} = \frac{{ℒ}_{ℱ , ‖}}{2} + \frac{{ℒ}_{ℱ , ∠}}{2}$$

In Equation Set 17, |·|₁ is the L1 norm.

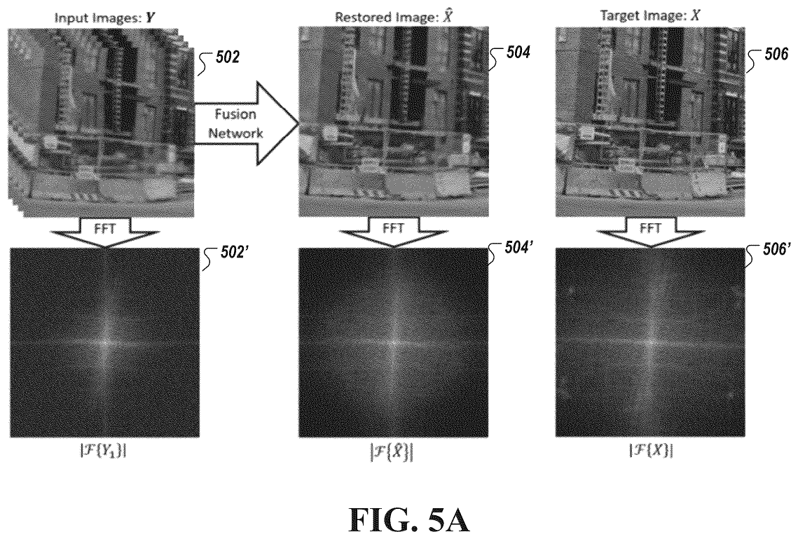

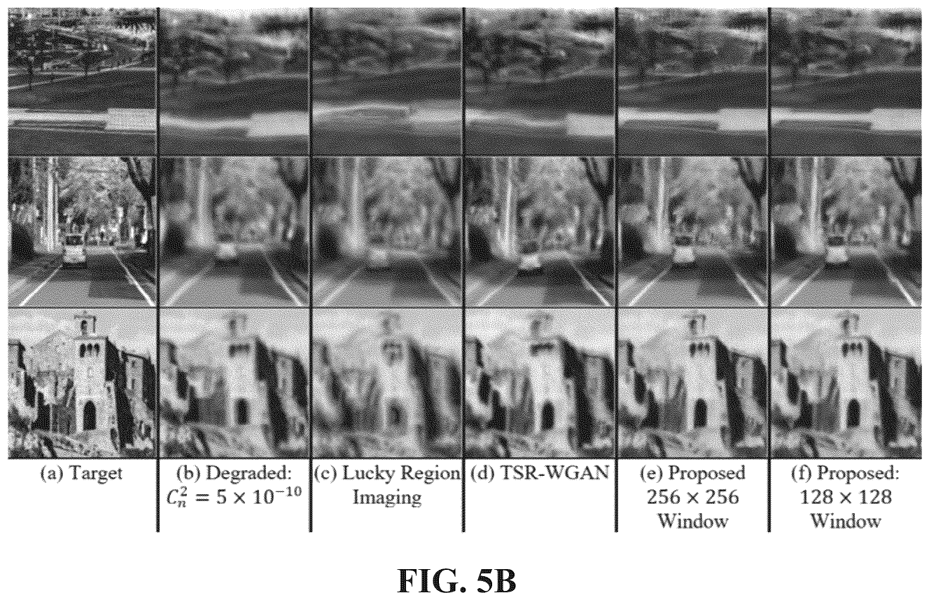

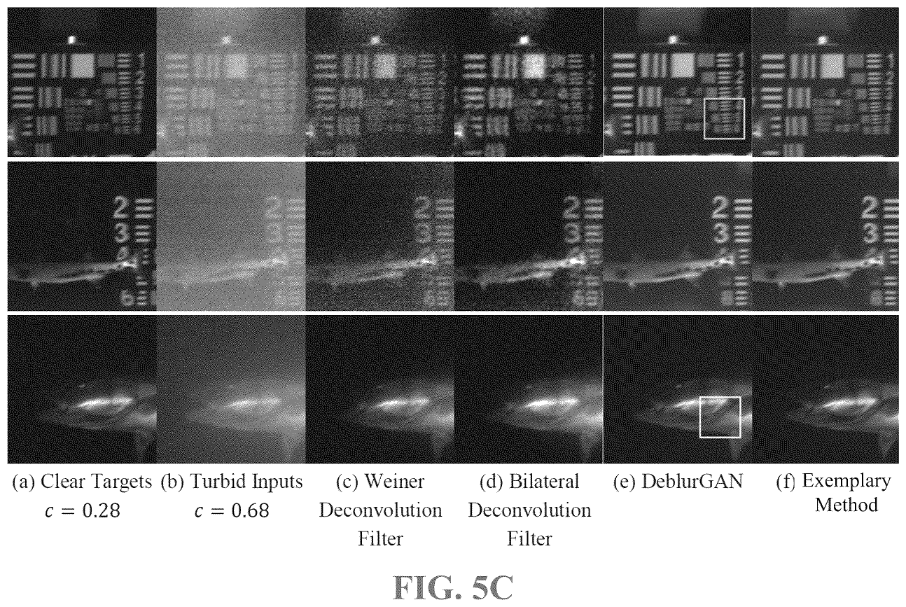

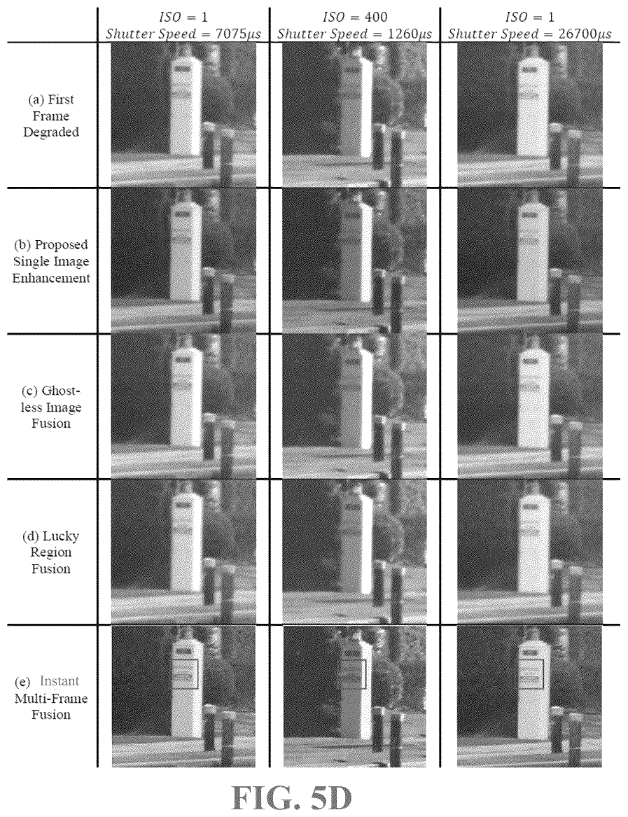

The incorporation of Fourier space loss can reflect how turbulence is modeled by a corruption in the phase domain of the wavefront. By allowing the image enhancement network to observe image differences in the Fourier domain, the effects caused by geometric distortion from imaging through turbulence can be significantly reduced. Additionally, images with higher frequency content can be represented and recognized when they are transformed into the frequency domain. The Fourier Space transform of a first degraded input frame 304 (shown as 502, 502′), target frame 314 (shown as 504, 504′), and restored frame 310 (shown as 506, 506′) are shown in FIG. 5A. It can be seen that the restored image (504) can recover higher frequency content and produce an image that more accurately reflects the spatial and frequency domain of the target image (506).

For example, the Fourier Space transform of the first degraded input frame, target frame, and restored frame are shown in FIG. 5A. It can be seen that the restored image can recover higher frequency content and produce an image that more accurately reflects the spatial and frequency domain of the target image.

### Example Method of Training a Neural Network for Single Images

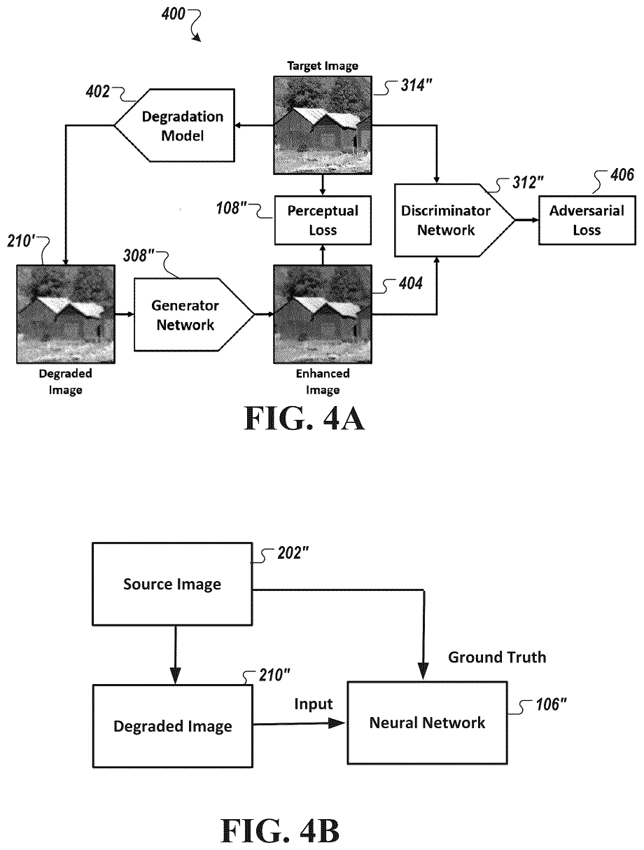

FIG. 4A shows a method 400 of using a generative adversarial network to generate a trained neural network employing a perceptual loss function (e.g., 108) that includes both spatial- and frequency-domain loss components, to remove turbulence effects from an image degraded by turbulence effect. In FIG. 4A, an image degradation model 402, e.g., as described in relation to FIG. 2A, is used to synthetically generate the degraded image 210 (shown as 210′) that is used as the input to the generator 308 (shown as 308′). The output of the generator 308′ is the enhanced image 404. A perceptual loss function 108 (shown as 108″) is then computed against the target 314 (shown as 314″) and enhanced image 404 to direct the generator 308″. The discriminator 312 (shown as 312″) then takes the target 314″ and enhanced image 404 to form the adversarial loss 406.

The generative adversarial network (GAN) may include two network models: a generator (G) and a discriminator (D). For image enhancement, the condition y can be the input degraded image that is fed into the generator in which the goal of the discriminator is to determine the probability that the generated samples are part of the target distribution. In other words, the discriminator is a critic in differentiating the real and fake samples. The goal of the generator is to fool the discriminator into thinking that the generated samples are part of the target distribution. Together, both networks play a minimax game where the objective function for CGAN is given as, e.g., Equation 11. The objective function may be alternatively expressed by

$${min}_{G} {max}_{D} {E}_{X ∼ {𝒫}_{x}} [ log ( D ( x \vert y ) ] + {E}_{Y ∼ {𝒫}_{y}} [ log ( D ( G ( y ) ) ) ] ,$$

where [symbol] is the data distribution of target x, [symbol] _{y} is the data distribution of conditional input y, and E is the expected value. The optimal value for the discriminator can be when the distribution of the output of the generator is equal to the distribution of the target data, e.g., D*(x)=½. When the discriminator is optimal, the objective function of CGAN can quantify the similarity between the distribution of the generated samples and the real samples by the Jensen-Shannon (JS) divergence, e.g., per Equation 18.

$${D}_{JS} ( {𝒫}_{x} \vert \vert {𝒫}_{\hat{x}} ) = \frac{1}{2} {D}_{KL} ( {𝒫}_{x} \vert \vert \frac{{𝒫}_{x} + {𝒫}_{\hat{x}}}{2} ) + \frac{1}{2} {D}_{KL} ( {𝒫}_{\hat{x}} \vert \vert \frac{{𝒫}_{x} + {𝒫}_{\hat{x}}}{2} ) \qquad ( Eq . 18 )$$

Wasserstein GAN (WGAN) can replace the JS-divergence with the Wassertaein-1 distance, also known as Earthmovers (EM) distance. Description may be found in Arjovsky et al. (2017).

In FIG. 4A, the objective of the discriminator is to minimize the discriminator loss given per Equation 13. The objective of the generator is to minimize the overall generator loss ( [symbol] ) that is given as a combination of adversarial loss ( [symbol] ) and perceptual loss ( [symbol] ), per Equation 14. The adversarial loss is the summation of negative scores of the generated image given by the discriminator network, per Equation 15.

The overall perceptual loss can be written as Equation 16, or [symbol] ₚ= [symbol] _{VGG}+π_{C} [symbol] _{C} where λ_{C} is a weighting parameter that regulates the impact of the correntropy loss on the total perpetual loss.

FIG. 4B shows a method of using a neural network trained to remove turbulence effects from an image degraded by turbulence effect. In FIG. 4B, a source image 202 (shown as 202″) is used to synthesize a degraded image 210 (shown as 210″), e.g., as discussed in relation to FIG. 2A or 2B, among others, described or referenced herein. The source image 202″ is used as a ground truth in a training operation for a neural network 106 (shown as 106″ and the degraded image 210″ is used as the input training data set. Indeed, the neural network 106″ is not necessarily as GAN or a part thereof.

Machine Learning. The exemplary system and method, e.g., of FIG. 4B, among other described herein, can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., an error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down sampling). A fully-connected layer includes neurons, where each neuron is connected to all of the neurons in the previous layer. The layers are stacked similarly to traditional neural networks. GCNNs are CNNs that have been adapted to work on structured datasets such as graphs.

The term “generative adversarial network” (or simply “GAN”) refers to a neural network that includes a generator neural network (or simply “generator”) and a competing discriminator neural network (or simply “discriminator”). More particularly, the generator learns how, using random noise combined with latent code vectors in low-dimensional random latent space, to generate synthesized images that have a similar appearance and distribution to a corpus of training images. The discriminator in the GAN competes with the generator to detect synthesized images. Specifically, the discriminator trains using real training images to learn latent features that represent real images, which teaches the discriminator how to distinguish synthesized images from real images. Overall, the generator trains to synthesize realistic images that fool the discriminator, and the discriminator tries to detect when an input image is synthesized (as opposed to a real image from the training images).

As used herein, the terms “loss function” or “loss model” refer to a function that indicates loss errors. As mentioned above, in some embodiments, a machine-learning algorithm can repetitively train to minimize overall loss. In some embodiments, the personalized fashion generation system employs multiple loss functions and minimizes overall loss between multiple networks and models. Examples of loss functions include a softmax classifier function (with cross-entropy loss), a hinge loss function, and a least squares loss function.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop a multi-frame image enhancement and fusion algorithm. Several experiments were conducted at the Naval Research Lab at Stennis Space Center Simulated Turbulence and Turbidity Environment (NRL-SSC SiTTE), employing the developed method, which is the basis for the exemplary system and method described herein. NRL-SSC SiTTE is a unique underwater turbulence testing facility that features a five-meter-long Rayleigh-Bénard convective tank that can simulate a broad range of turbulence and turbidity observed in nature. The SiTTe convective tank was used as a testbed for repeatable experiments to study the impact of optically active turbulence on image degradation.

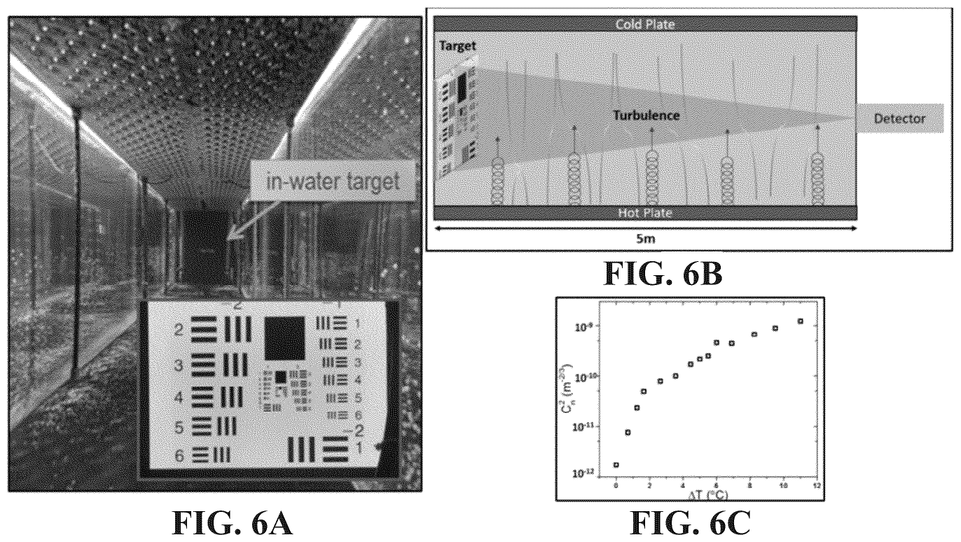

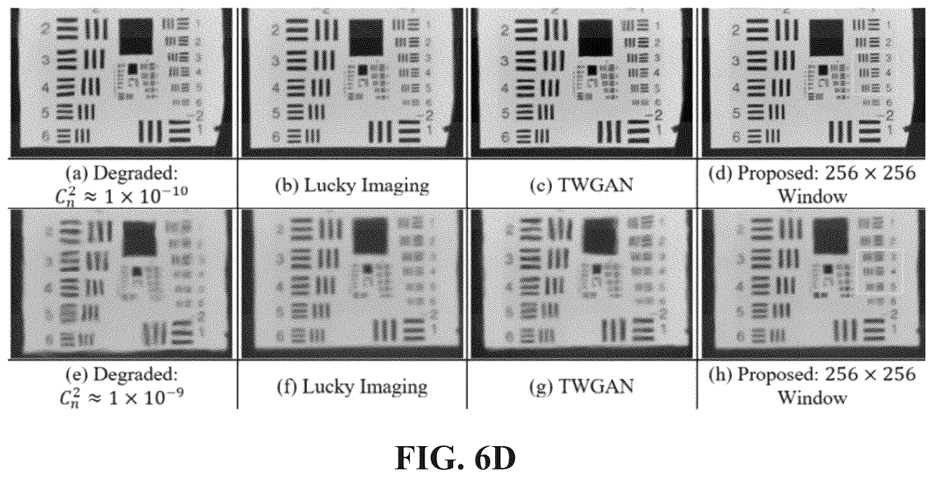

FIGS. 6A-6C shows a characterization of the test system used for the turbulence imaging experiment. FIG. 6C shows the relationship between Cₙ² and the temperature difference between the hot and cold plates of the NRL-SSC SiTTE test facility (Ouyang et al. 2016). The in-water target shown in FIG. 6A was used to capture images under Low and High turbulence. This was done by creating a temperature difference between the cold and hot plates. The Low turbulence was produced with a temperature difference between the bottom and top plates of ΔT≈4° C., and the High optical turbulence with ΔT≈13° C. The turbulence index, Cₙ², for the strong and extreme turbulences were estimated to be approximately 1e⁻¹⁰ and 1e⁻⁹. respectively (Matt et al. 2020).

Training. To train the machine learning-based multi-frame image enhancement algorithm, the DIV2K dataset from the 2018 NTIRE challenge on single image super-resolution and a subset of the Flickr30K dataset are used to synthetically generate N degraded images from a single target image. These datasets consist of a wide variety of high-resolution images of different scenes and objects that will be used as the target images. The images were degraded using the image degradation model described in relation to FIG. 2A. For the training dataset, the diameter of the lens aperture, d, and focal length were fixed to 10 mm and 50 mm, respectively. The wavelength of the light, λ, was assumed to be 550 nm and the propagation length, L, is set as 5 m. To simulate detector noise, shot noise was applied pixel-wise to the entire image. For each image generated, the turbulence index, Cₙ₂, and noise scale parameter, σ_{N}, were randomly selected from selected range with a uniform distribution. This allowed the network to observe a specified domain of turbulence indices and noise levels. The turbulence index is varied between 1×10⁻¹⁰ and 1×10⁻⁹. The noise scale parameter was varied between 1×10⁵ and 1×10³. The generated image stack was globally aligned to the target frame using the DFT image registration scheme.

The network was trained by using image patches of size 64×64 that were randomly cropped from the full-sized training image pairs. The image patch set iwass then locally aligned using another iteration of DFT image registration. A total of 10,000 patch pairs were used to train the network. For better training convergence, a batched training scheme was used with 10 image sets per batch, giving 1000 iterations per training epoch. The network was trained for 200 epochs, resulting in 200,000 updates for the entire training session. The ADAM optimizer was used with a learning rate of αₗ=0.0002, and decay factors set as β₁=0.9 and β₂=0.99. The training was performed using a Pytorch framework on a single 12 GB NVIDIA Geforce GTX Titan X GPU and took approximately 4 days to complete the training session. After the training was completed, only the generator network is required for the image fusion process.

Validation. For validation, two different validation datasets were synthetically generated to validate the performance of the exemplary network against extreme turbulence (Cₙ²=1×10⁻⁹). Each dataset contained 100 image pairs of degraded and target images that were generated using a turbulence image degradation model. The diameter of the lens aperture, d, and focal length were set as 10 mm and 50 mm, respectively. The wavelength of the light, λ, was assumed to be 550 nm, and the propagation length, L, is set as 5 m. The detector noise of the camera was simulated using shot noise with the noise scale parameter set as σ_{N}=1×10³. Each stack of captured images consisted of N=9 images with a window size of 256×256 across both axes. The restoration technique was also applied with a smaller window of size 128×128 for evaluation.

In addition to the validation operation, the study evaluated the performance of the exemplary network by comparing the exemplary network to the lucky region imaging technique proposed in (Mao et al. 2020) and the TSR-WGAN network proposed in (Jin et al. 2021). The comparison was based on an average Peak Signal to Noise Ratio (PSNR) and average Structured Similarity Image Metric (SSIM) scores of the entire validation sets for each turbulence level. Table 1 shows the resulting scores along with the scores given by the first frame of the degraded input. FIG. 5B, panels A-F contains a subset of images restored with these methods for visual comparison.

Per Table 1, it can be observed that the exemplary trained network achieved the highest average SSIM score for both levels of turbulence and the highest average PSNR for the Extreme turbulence case. In contrast, the Lucky Imaging technique only achieved the best average PSNR scores for the Strong turbulence case. The PSNR image metric was known to not accurately represent the human perception of image quality (Fardo et al. 2016). It can be seen that the exemplary network can produce images that are sharper and have less noise than the image restored by the Lucky Imaging technique and TWGAN. In addition, the network is also able to significantly correct for the geometric distortion caused by turbulence-induced image degradation (FIGS. 5B, 5D, 6D).

TABLE 1
Average PSNR and SSIM scores of 100 validation images
for the first frame of the degraded input sequence, average
of the image sequence, the images restored by the lucky
region imaging technique (Miao et al. 2018), TSR-WGAN
(Jin et al. 2021), and the exemplary method.

| | Strong Turbulence: | | Extreme Turbulence: | |
|---|---|---|---|---|
| | Cₙ² = 5 × 10⁻¹⁰ | | Cₙ² = 1 × 10⁻⁹ | |
| | PSNR | | PSNR | |
| Model | [dB] | SSIM | [dB] | SSIM |
| Degraded First Frame | 18.403 | 0.416 | 17.706 | 0.400 |
| Lucky Imaging (Purdue) | 20.659 | 0.519 | 19.637 | 0.481 |
| TSR-WGAN | 19.193 | 0.477 | 18.510 | 0.445 |
| Exemplary Algorithm with | 20.482 | 0.534 | 19.811 | 0.488 |
| 256 × 256 Window | | | | |
| Exemplary Algorithm with | 20.384 | 0.524 | 19.699 | 0.478 |
| 128 × 128 Window | | | | |

Indeed, it can be observed that the exemplary system and associated method of training can significantly reduce the geometric distortion due to underwater turbulence. In particular, the bars and numbers of the USAF-1951 (FIG. 6D, panels D and H) are seen to be straighter and more distinct in the images produced by the exemplary method for both turbulence cases. These visual observations validate that the exemplary method can be used to correct images degraded by turbulence and provide perceptually better results than the lucky region technique and the TSR-WGAN network.

### DISCUSSION

Unmanned aerial vehicles (UAVs) and unmanned underwater vehicles (UUVs) have gained popularity, especially for long-duration surveillance missions, due to their low operation cost and reduced human safety risks. Sensors (e.g., electro-optical [EO] imagers) need to be compact and energy efficient to be compatible with the tight resource budgets of such platforms. These constraints are exacerbated when the system operates in degraded visual environments such as scattering (induced by fog, turbid coastal water), or turbulence. Recent research (Hou 2009, Hou et al. 2012) has modeled and demonstrated the effects of turbulence on EO imaging in the natural environment, which confirmed early observations and hypotheses (Gilbert and Honey, 1972). It seems that turbulence affects imaging transfer in a different manner than scattering. In a strong scattering environment such as turbid water, the absorption reduces all spatial frequencies somewhat evenly. In contrast, turbulence seems to limit imaging capabilities at sharp cut-off frequencies beyond which imaging information is lost. A cumulative, transformational approach different from traditional Fourier domain decomposition is needed to overcome such challenges.

In recent years, there has been substantial work done to mitigate image impairment due to the distortions from the turbulent medium. The approaches range from the lucky imaging technique, where a sequence of images is each divided into patches, and the best patches from these images are then assembled to produce a reasonably undistorted image (Murase, 1992, Wen et al., 2010, Ouyang et al. 2016). In particular, Fourier domain spectral analysis was incorporated in Wen et al. to improve the image reconstruction results. The reason that Fourier domain spectral analysis plays an important role in mitigating image degradation from the impact of random medium such as turbulence is that the primary source of distortion from such medium is the phase distortion of the wavefront of the light in the Fourier domain.

In recent years, machine learning-based turbulence mitigation techniques have gained significant interest. For example, a temporal-spatial residual perceiving Wasserstein GAN for turbulence-distorted sequence restoration (TSR-WGAN) is proposed to compensate for atmospheric turbulence for images captured in complex and dynamic scenes (Jin et al., 2021). One aspect in the design of the machine learning, in particular, generative adversarial network (GAN) based image restoration framework, is the perceptual loss function to guide the generator network by comparing low-level and high-level differences between the restored and target image. The aforementioned TSR-WGAN and many other techniques all employ conventional spatial domain loss functions—i.e., measuring the distortion in the original image domain. One fundamental limitation of such a choice when attempting to mitigate the turbulence-impaired images is that in the spatial domain, the distortions induced by the perturbations of the Fourier phases will be much more difficult to be localized. For example, while a structure consists of a few frequency components in the Fourier space, quite complex patterns can be present in the spatial domain (i.e., appear to be random). As such, it will be much more challenging for the network to learn such a type of impact. In turn, the network performance will therefore be suboptimal and difficult to train.

In the instant study, a loss function in the Fourier domain was adopted to directly evaluate the source of the distortion—i.e., phase distortion in the Fourier domain. Such a choice can allow the network to learn the type of distortions directly and in a much more constrained space since, in many cases; there are only a small number of dominant frequency components.

Example Computing Device. Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing systems (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or codes on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

### CONCLUSION

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising,” particularly in a description of components of a composition or in a description of elements of a device, can be exchanged with “consisting essentially of” or “consisting of.” The invention illustratively described herein suitably may be practiced in the absence of any element or elements, limitation, or limitations which is not specifically disclosed herein. In each instance herein, any of the terms “comprising,” “consisting essentially of,” and “consisting of” may be replaced with either of the other two terms.

All patents and publications mentioned in the specification are indicative of the levels of skill of those skilled in the art to which the invention pertains. References cited herein are incorporated by reference herein in their entirety to indicate the state of the art as of their filing date, and it is intended that this information can be employed herein, if needed, to exclude specific embodiments that are in the prior art.

One skilled in the art will readily appreciate that the present invention is well adapted to carry out the objects and obtain the ends and advantages mentioned, as well as those inherent therein. The devices, device elements, methods, and materials described herein as presently representative of preferred embodiments are exemplary and are not intended as limitations on the scope of the invention. Changes therein and other uses will occur to those skilled in the art and are intended to be encompassed within this invention.

As used herein, “about” refers to a value that is 10% more or less than a stated value.

The following patents, applications, and publications, as listed below and throughout this document, are hereby incorporated by reference in their entirety herein.

### REFERENCES

[1] D. Jin, Y. Chen, Y. Lu, J. Chen, P. Wang, Z. Liu, S. Guo and X. Bai., “Neutralizing the impact of atmospheric turbulence on complex scene imaging via deep learning,” Nature Machine Intelligence, vol. 3, no. 10, pp. 876-884, 2021.
[2] H. Weilin, S. Woods, E. Jarosz, W. Goode and A. Weidemann, “Optical turbulence on underwater image degradation in natural environments,” Applied Optics, vol. 51, no. 14, pp. 2678-2686, 2012.
[3] W. W. Hou, “A simple underwater imaging model,” Optics letters, vol. 34, no. 17, pp. 2688-2690, 2009.
[4] G. D. Gilbert and R. C. Honey, “Optical turbulence in the sea,” Underwater Photo-optical Instrumentation Applications, vol. SPIE, p. 49-55, 1972.
[5] B. Ouyang, W. Hou, C. Gong, F. R. Dalgleish, F. M. Caimi, A. K. Vuorenkoski, G. Nootz, X. Xiao and D. G. Voelz, “Experimental study of a compressive line sensing imaging system in a turbulent environment,” Applied optics, vol. 55, no. 30, pp. 8523-8531, 2016.
[6] B. Ouyang and W. Hou, “Investigation of the compressive line sensing imaging system in a controlled hybrid scattering environment,” In Ocean Sensing and Monitoring X, vol. 10631, p. 106310M. International Society for Optics and Photonics, 2018.
[7] G. Potvin, J. L. Forand and D. Dion, “A simple physical model for simulating turbulent imaging,” in Proceedings of SPIE, vol. 8014, pp. 8014Y. 1-13, 2011.
[8] J. H. a. D. E. O. K. R. Leonard, “Simulation of atmospheric turbulence effects and mitigation algorithms on standoff automatic facial recognition,” Proc. SPIE 8546, Optics and Photonics for Counterterrorism, Crime Fighting, and Defence VIII, Oct, pp. 1-18, 2012.
[9] J. P. Bos and M. C. Roggemann, “Technique for simulating anisoplanatic image formation over long horizontal paths,” Optical Engineering, vol. 51, no. 10, p. 101704.1-101704.9, 2012.
[10] N. Chimitt and S. H. Chan., “Simulating anisoplanatic turbulence by sampling intermodal and spatially correlated Zernike coefficients,” Optical Engineering, vol. 59, no. 8, 2020.
[11] B. Wronski, I. Garcia-Dorado, M. Ernst, D. Kelly, M. Krainin, C. K. Liang, M. Levoy and P. Milanfar., “Handheld multi-frame super-resolution,” ACM Transactions on Graphics (TOG), vol. 38, no. 4, pp. 1-18, 2019.
[12] N. Hayat and M. Imran, “Ghost-free multi exposure image fusion technique using dense SIFT descriptor and guided filter,” Journal of Visual Communication and Image Representation, vol. 62, pp. 295-308, 2019.
[13] X. Zhu and P. Milanfa, “Removing atmospheric turbulence via space-invariant deconvolution,” IEEE transactions on pattern analysis and machine intelligence, vol. 1, no. 35, pp. 157-170, 2012.
[14] M. Aubailly, M. A. Vorontsov, G. W. Carhart and M. T. Valley, “Automated video enhancement from a stream of atmospherically-distorted images: the lucky-region fusion approach,” In Atmospheric Optics: Models, Measurements, and Target-in-the-Loop Propagation III, vol. 7463, p. 74630C. International Society for Optics and Photonics, 2009.
[15] Z. Mao, N. Chimitt and S. H. Chan, “Image reconstruction of static and dynamic scenes through anisoplanatic turbulence,” IEEE Transactions on Computational Imaging, vol. 6, pp. 1415-1428, 2020.
[16] O. Kupyn, V. Budzan, M. Mykhailych, D. Mishkin and J. Matas, “Deblurgan: Blind motion deblurring using conditional adversarial networks,” Proceedings of the IEEE Conference on Computer Vision and Pattern Recognition, Vols. 8183-8192, 2018.
[17] S. Zhang, A. Zhen and R. Stevenson, “GAN Based Image Deblurring Using Dark Channel Prior,” Electronic Imaging, no. 13, pp. 136-1, 2019.
[18] M. Chu, Y. Xie, L. Leal-Taixé and a. N. Thuerey, “Temporally coherent gans for video super-resolution (tecogan),” arXiv preprint arXiv: 1811.09393, vol. 1, no. 2, p. 3, 2018.
[19] D. Estrada, S. Lee, F. Dalgleish, C. D. Ouden, M. Young, C. Smith, J. Desjardins and B. Ouyang, “DeblurGAN-C: image restoration using GAN and a correntropy based loss function in degraded visual environments,” Proc. SPIE. 11395, Big Data II: Learning, Analytics, and Applications, 2020.
[20] W. Liu, P. Pokharel and J. Principe, “Correntropy: A localized similarity measure,” The 2006 IEEE international joint conference on neural network proceedings, pp. 4919-4924, 2006.
[21] D. Fuoli, L. V. Gool and R. Timofte, “Fourier space losses for efficient perceptual image super-resolution,” In Proceedings of the IEEE/CVF International Conference on Computer Vision, pp. 2360-2369, 2021.
[22] F. R. Dalgleish, A. K. Vuorenkoski and B. Ouyang, “Extended-Range Undersea Laser Imaging: Current Research Status and a Glimpse at Future Technologies,” Marine Technology Society Journal, vol. 47, no. 5, pp. 128-147, 2013.
[23] S. C. Park, M. K. Park and M. G. Kang, “Super-resolution image reconstruction: a technical overview,” IEEE signal processing magazine, vol. 20, no. 3, pp. 21-36, 2003.
[24] J. Xiao, H. Yong and L. Zhang, “Degradation Model Learning for Real-World Single Image Super-resolution,” In Proceedings of the Asian Conference on Computer Vision, 2020.
[25] R. D. Gow, D. Renshaw, K. Findlater, L. Grant, S. J. McLeod, J. Hart and R. L. Nicol, “A comprehensive tool for modeling CMOS image-sensor-noise performance,” IEEE Transactions on Electron Devices, vol. 54, no. 6, pp. 1321-1329, 2007.
[26] M. Potmesil and I. Chakravarty, “Synthetic image generation with a lens and aperture camera model,” ACM Transactions on Graphics (TOG), vol. 1, no. 2, pp. 85-108, 1982.
[27] V. I. Tatarski, Wave propagation in a turbulent medium, Courier Dover Publications, 2016.
[28] D. L. Fried, “Probability of getting a lucky short-exposure image through turbulence,” JOSA, vol. 68, no. 12, pp. 1651-1658, 1978.
[29] R. J. Noll, “Zernike polynomials and atmospheric turbulence,” JOSA, vol. 66, no. 3, pp. 207-211, 1976.
[30] A. Theuwissen, “The effect of shrinking pixels in existing CMOS technologies,” In Proc. Fraunhofer IMS Workshop CMOS Imag, pp. 14-30, 2002.
[31] X. Jin and K. Hirakawa, “Approximations to camera sensor noise,” In Image Processing: Algorithms and Systems XI, International Society for Optics and Photonics, vol. 8655, p. 86550H, 2013.
[32] B. Zitova and J. Flusser, “Image registration methods: a survey.” 21, no. 11 (2003):” Image and vision computing, vol. 21, no. 11, pp. 977-1000, 2003.
[33] M. Guizar-Sicairos, S. T. Thurman and James R. Fienup, “Efficient subpixel image registration algorithms,” Opt. Lett., vol. 33, pp. 156-158, 2008.
[34] M. Zheng, T. Li, R. Zhu, Y. Tang, M. Tang, L. Lin and Z. Ma, “Conditional Wasserstein generative adversarial network-gradient penalty-based approach to alleviating imbalanced data classification,” Information Sciences, vol. 512, pp. 1009-1023, 2020.
[35] P. Isola, J. Y. Zhu, T. Zhou and A. A. Efros, “Image-to-image translation with conditional adversarial networks,” In Proceedings of the IEEE conference on computer vision and pattern recognition, pp. 1125-1134, 2017.
[36] H. Ren, M. El-Khamy and J. Lee, “Dn-resnet: Efficient deep residual network for image denoising,” In Asian Conference on Computer Vision, pp. 215-230, 2018.
[37] H. Zhao, O. Gallo, I. Frosio and J. Kautz, “Loss functions for image restoration with neural networks,” IEEE Transactions on computational imaging, vol. 3, no. 1, pp. 47-57, 2016.
[38] Z. Wang, A. C. Bovik, H. R. Sheikh and E. P. Simoncelli, “Image quality assessment: from error visibility to structural similarity,” IEEE transactions on image processing, vol. 13, no. 4, pp. 600-612, 2004.
[39] D. C. Estrada, F. R. Dalgleish, C. J. D. Ouden, B. Ramos, Y. Li and B. Ouyang, “Underwater LiDAR Image Enhancement Using a GAN Based Machine Learning Technique,” IEEE Sensors Journal, vol. 22, no. 5, pp. 4438-4451, 2022.
[40] S. Matt, W. Hou, W. Goode and S. Hellman, “Introducing SiTTE: A controlled laboratory setting to study the impact of turbulent fluctuations on light propagation in the underwater environment,” Optics Express 25, vol. 5, pp. 5662-5683, 2017.
[41] S. Matt, G. Nootz, S. Hellman and W. Hou, “Effects of optical turbulence and density gradients on particle image velocimetry,” Scientific Reports, vol. 10, no. 1, pp. 1-12, 2020.
[42] R. Timofte, S. Gu, J. Wu, L. Van Gool and L. Zhang, “NTIRE 2018 Challenge on Single Image Super-Resolution: Methods and Results,” The IEEE Conference on Computer Vision and Pattern Recognition (CVPR) Workshops, 2018.
[43] P. Young, A. Lai, M. Hodosh and J. Hockenmaier, “From image descriptions to visual denotations: New similarity metrics for semantic inference over event descriptions,” Transactions of the Association for Computational Linguistics, vol. 2, pp. 67-78, 2014.
[44] F. A. Fardo, V. H. Conforto, F. C. d. Oliveira and P. S. Rodrigues, “A Formal Evaluation of PSNR as Quality Measurement Parameter for Image Segmentation Algorithms,” Computer Vision and Pattern Recognition, 2016.
[45] Z. Miao, F. Yuan, C. GAO and E. Cheng, “New non-reference image quality evaluation method for underwater turbulence blurred images,” In Proceedings of the Thirteenth ACM International Conference on Underwater Networks & Systems, pp. 1-8, 2018.
[46] M. Rajchel and M. Oszust, “No-reference image quality assessment of authentically distorted images with global and local statistics,” Signal, Image and Video Processing, vol. 15, no. 1, pp. 83-91, 2021.
[47] M. Trivedi, A. Jaiswal and V. Bhateja, “A novel HVS based image contrast measurement index,” In Proceedings of the Fourth International Conference on Signal and Image Processing 2012 (ICSIP 2012), pp. 545-555, 2013.
[48] Q. Jiang, Z. Liu, K. Gu, F. Shao, X. Zhang, H. Liu and W. Lin, “Single image super-resolution quality assessment: a real-world dataset, subjective studies, and an objective metric,” IEEE Transactions on Image Processing, 2022.
[49] M. Arjovsky, S. Chintala and L. Bottou, “Wasserstein generative adversarial networks,” 2017, pp. 214-223, In International conference on machine learning.

What is claimed is:

1. A method comprising:
receiving and/or generating a training data set comprising a plurality of simulated degraded images capturing the degradation in turbulent medium with varying turbulence strengths and corresponding to a target image or object, wherein the plurality of simulated degraded images are provided as multiple frame images into inputs of an artificial neural network;
evaluating, by a processor, via the training, the performance of the artificial neural network using the multiple frame images to recognize differences between the plurality of degraded images in a turbulent medium and the target image using a perceptual loss function, wherein the perceptual loss function comprises a spatial domain loss component and a frequency domain loss component; and
adjusting, by a processor, a weighting parameter of the artificial neural network based on the loss function to generate a trained neural network, wherein, once trained, the trained neural network is configured to enhance actual images taken in a turbulent medium.

2. The method of claim 1, wherein the artificial neural network comprises ResNet layers.

3. The method of claim 1, further comprising globally and locally aligning the plurality of images prior to evaluating the performance of the artificial neural network.

4. The method of claim 1, wherein the perceptual loss function further comprises a spatial correntropy-based loss component and Fourier space-loss.

5. The method of claim 1, further comprising:
generating a set of simulated degraded image generated from one or more source images, wherein the generating provides a motion vector to offset values of reference pixels of the source image to geometrically warp and/or distort the one or more source image.

6. The method of claim 1, wherein the artificial neural network comprises a GAN network.

7. A system comprising:
a processor; and
a memory having instructions stored thereon, wherein the instructions, when executed by the processor, causes the processor to:
receive one or more images having a distortion;
generate one or more cleaned images from the received one or more images using a trained neural network having been trained using a perceptual loss function comprising a spatial domain loss component and a frequency domain loss component; and
output the generated one or more cleaned images.

8. The system of claim 7, wherein the one or more images include underwater images through turbulence.

9. The system of claim 7, wherein the one or more images include terrestrial images through turbulence.

10. The system of claim 7, wherein the one or more images include satellite images through turbulence.

11. The system of claim 7, wherein the trained neural network was generated by:
providing a training data set comprising a plurality of degraded images corresponding to a target image to an artificial neural network;
evaluating the performance of the artificial neural network to recognize the differences between the plurality of degraded images and the target image using a perceptual loss function, wherein the perceptual loss function comprises a spatial domain loss component and a frequency domain loss component; and
adjusting a weighting parameter of the artificial neural network based on the loss function to generate a trained neural network.

12. The system of claim 10, wherein the perceptual loss function comprises spatial correntropy-based loss and Fourier space-loss.

13. The system of claim 10, wherein the system comprises real-time vehicle control configured to employ the one or more cleaned images in the control of the vehicle.

14. The system of claim 10, wherein the system comprises a post-processing system configured to post-process the one or more images having the distortion to generate the one or more cleaned images.

15. A non-transitory computer-readable medium having instructions stored thereon, wherein the instructions, when executed by a processor, causes the processor to:
receive one or more images having a distortion;
generate one or more cleaned images from the received one or more images using a trained neural network having been trained using a perceptual loss function comprising a spatial domain loss component and a frequency domain loss component; and
output the generated one or more cleaned images.

16. The non-transitory computer-readable medium of claim 15, wherein the one or more images include underwater images through turbulence.

17. The non-transitory computer-readable medium of claim 15, wherein the one or more images include terrestrial images through turbulence.

18. The non-transitory computer-readable medium of claim 17, wherein the one or more images include satellite images through turbulence.

19. The non-transitory computer-readable medium of claim 17, wherein the trained neural network was generated by:
providing a training data set comprising a plurality of degraded images corresponding to a target image to an artificial neural network;
evaluating the performance of the artificial neural network to recognize differences between the plurality of degraded images and the target image using a perceptual loss function, wherein the perceptual loss function comprises a spatial domain loss component and a frequency domain loss component; and
adjusting a weighting parameter of the artificial neural network based on the loss function to generate a trained neural network.

20. The non-transitory computer-readable medium of claim 17, wherein the perceptual loss function further comprises a spatial correntropy-based loss and Fourier space-loss.
